(19) United States
(12) Patent Application Publication
(10) Pub. No.: US 2024/0095351 A1
(43) Pub. Date: Mar. 21, 2024

(54) HYPERVISOR-ASSISTED DATA BACKUP AND RECOVERY FOR NEXT GENERATION ANTI-VIRUS (NGAV) SYSTEMS

(71) Applicant: VMware, Inc., Palo Alto, CA (US)

(72) Inventors: Shirish VIJAYVARGIYA, Pune (IN); Vasantha Kumar DHANASEKAR, Pune (IN); Bidesh CHITNIS, Pune (IN); Nakul Ranjan OGALE, Pune (IN); Bharath Kumar CHANDRASEKHAR, Sunnyvale, CA (US); Boris WEISSMAN, Palo Alto, CA (US); Robert James SPEAKER, Barrington, RI (US)

(21) Appl. No.: 17/948,104

(22) Filed: Sep. 19, 2022

(51) Int. Cl. G06F 21/55; G06F 21/56

(52) U.S. Cl. CPC G06F 21/554; G06F 21/552; G06F 21/564

(57) ABSTRACT

In one set of embodiments, an enhanced next generation anti-virus (NGAV) system is provided. In certain embodiments, this system includes a hypervisor-level agent that backs up VM data only when an instance of a guest application running in the VM has been flagged by the NGAV system as being potentially malicious (rather than on a constant, proactive basis). Further, the hypervisor-level agent performs this backup only with respect to data modified by that specific guest application instance (rather than backing up all data modified by the VM) and writes the backed-up data to a secure storage location which is inaccessible to the guest. The combination of these features addresses many of the problems and inefficiencies of existing NGAV systems.

### BACKGROUND

Unless otherwise indicated, the subject matter described in this section is not prior art to the claims of the present application and is not admitted as being prior art by inclusion in this section.

Virtual machines (VMs) that run workloads for organizations are often the target of malicious software such as viruses, ransomware, spyware, and the like (collectively referred to herein as malware). In recent years, cloud-based next generation anti-virus (NGAV) systems have been developed to address this problem. Unlike conventional anti-virus programs that identify malicious code using a database of known malware signatures, NGAV systems employ behavior-based techniques to analyze the runtime activities of guest applications within VMs for suspicious patterns. With this approach, NGAV systems can advantageously detect never-seen-before malware rather than only known threats.

Because the behavior-based techniques used by NGAV systems generally require the collection and analysis of a relatively large set of application activity data to produce an accurate result, it typically takes some time (e.g., on the order of hours or days) for such systems to confidently determine whether a running instance of a guest application is in fact malicious. During this time window the guest application instance cannot be halted, because doing so might prevent legitimate application execution. This results in the following issues and inefficiencies:
1. False positive alerts—For guest applications that are legitimate but exhibit suspicious activity patterns due to their nature (e.g., data cleanup utilities that erase backed up data, etc.), existing NGAV systems will typically generate several false positive alerts during their initial stages of analyzing instances of these applications, which can be aggravating for administrators.
2. Overhead of data backup—Because guest application instances cannot be halted while their behavior is in the process of being analyzed, there is a need for a backup mechanism to enable the backup and recovery of data accessed by the application instances in case they are in fact malicious. With existing NGAV systems, administrators are generally required to procure, deploy, and maintain a separate VM-level backup solution that proactively backs up all data modified by a VM. This leads to a large amount of management overhead for the administrators, as well increased storage costs to hold the backed-up data and reduced VM I/O performance due to backing up every piece of data that is written.
3. Vulnerability of the backup mechanism—Existing VM-level backup solutions are vulnerable to guest malware and thus can be disabled (and its data backups corrupted/deleted) by a malicious guest application instance.

### BRIEF DESCRIPTION OF THE DRAWINGS

FIG. 1 depicts an example environment.

FIG. 2 depicts a modified version of the environment of FIG. 1 that implements an enhanced NGAV system according to certain embodiments.

FIGS. 3A and 3B depict a workflow executed by the enhanced NGAV system of FIG. 2 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to an enhanced NGAV system that enables intelligent hypervisor-assisted backup and recovery of VM data. As mentioned previously, an NGAV system is malware detection system that uses behavior-based techniques to identify malicious instances of guest applications running within VMs based on the activity patterns of those application instances. These behavior-based techniques can leverage machine learning (ML) and/or other types of behavior detection mechanisms.

In one set of embodiments, the enhanced NGAV system of the present disclosure includes a novel hypervisor-level agent that backs up VM data only when a guest application instance of the VM has been flagged by the NGAV system as being potentially malicious (rather than on a constant, proactive basis). Further, the hypervisor-level agent performs this backup only with respect to data modified by that specific guest application instance (rather than backing up all data modified by the VM) and writes the backed-up data to a secure storage location which is inaccessible to the guest. The combination of these features addresses many of the problems and inefficiencies of existing NGAV systems.

### 2. Example Environment and Solution Architecture

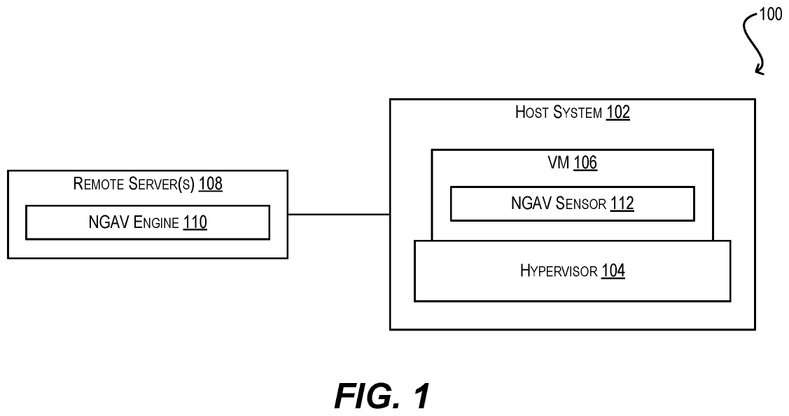

FIG. 1 depicts an example environment 100 in which the techniques of the present disclosure may be implemented. As shown, environment 100 includes a host system 102 running a hypervisor 104 and a VM 106 that is communicatively coupled with one or more remote (e.g., cloud) servers 108 running an NGAV engine 110. Although only a single host system is depicted for purposes of illustration, host system 102 may be part of a cluster of host systems in, e.g., a data center or other similar computing deployment.

NGAV engine 110 is a component of a conventional NGAV system that includes an NGAV sensor 112 running within VM 106 of host system 102. In operation, NGAV engine 110 receives from NGAV sensor 112 information regarding the behavior of guest application instances running in VM 106 and, for each such guest application instance, makes an initial determination on whether the guest application instance is likely malicious. If this initial determination is positive (i.e., the guest application instance is likely malicious), NGAV engine 110 generates an alert for the administrators of environment 100 and allows the guest application instance to continue running. During this time period, NGAV sensor 112 collects further data regarding the application instance's activity and sends the data to NGAV engine 110 for behavior-based analysis. Finally, upon completing its behavior-based analysis, NGAV engine 110 generates a final decision on whether the guest application instance is malicious.

As noted the Background section, there are a number of problems and inefficiencies with the general workflow above. First, because NGAV engine 110 generates an alert each time it makes an initial determination that a guest application instance is likely malicious, NGAV engine 110 can potentially produce a large volume of false positive alerts for the administrators of environment 100. This is particularly true if the environment's host systems run a large number of guest applications that are legitimate but exhibit activity patterns that are similar to malware, such as data cleanup utilities and the like. These false positive alerts can be annoying for the administrators and ultimately cause them to overlook genuine malware alerts generated by the system.

Second, because the guest application instances of VM 106 are allowed to continue running while NGAV engine 110 carries out its behavior-based analysis, there is a need for the administrators to procure, deploy, and configure a VM-level data backup solution that proactively backs up all of the data modified by VM 106, in case one or more of its guest application instances actually turn out to be malware. This incurs a significant amount of administrative overhead. In addition, there are storage costs associated with provisioning sufficient storage space to hold the backed-up VM data and performance costs associated with backing up every write I/O issued by the VM.

Third, because VM-level data backup solutions run at least partially at the guest level, they are vulnerable to guest malware. For example, if one of the guest application instances running within VM 106 is ransomware, that ransomware can take control of the backup solution and corrupt/delete its backups, thereby rendering the backup solution ineffective for its intended purpose.

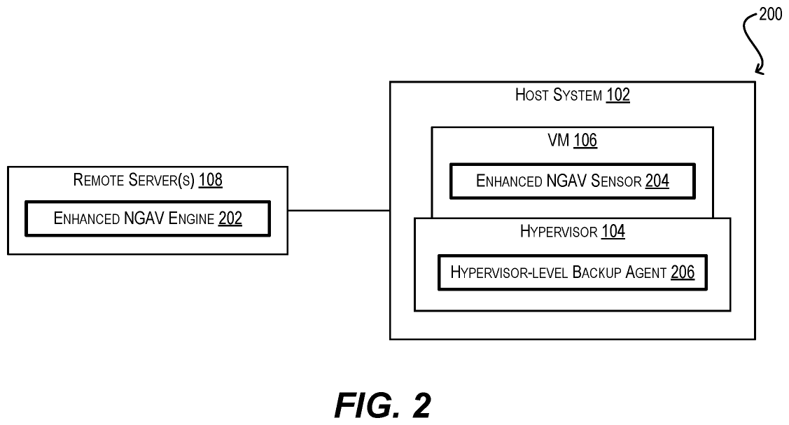

To address the foregoing and other related issues, FIG. 2 depicts a modified version of environment 100 of FIG. 1 (i.e., environment 200) that includes an enhanced NGAV system comprising an enhanced NGAV engine 202 on remote server(s) 108, an enhanced NGAV sensor 204 in VM 106, and a new hypervisor-level backup agent 206 in hypervisor 104.

At a high level, when a guest application instance of VM 106 attempts to perform an operation that may be indicative of malicious behavior, enhanced NGAV sensor 204 can temporarily halt the guest application instance and send information regarding the operation, as well as other activity performed by the guest application instance to that point (e.g., file accesses, network activity, registry accesses, etc.) to enhanced NGAV engine 202. In response, enhanced NGAV engine 202 can perform a preliminary analysis of the guest application instance based on the received information and make an initial determination on whether the guest application instace is malicious or not.

If the initial determination indicates that the guest application instance is malicious, enhanced NGAV engine 202 can inform hypervisor-level backup agent 206 of this fact. In addition, enhanced NGAV engine 202 can provide an indication to enhanced NGAV sensor 204 that the guest application instance should be allowed to continue its execution. Significantly, enhanced NGAV engine 202 can refrain from generating any type of alert for the administrators of environment 200 at this point.

Then, while the guest application instance continues running, enhanced NGAV sensor 204 can collect and send to enhanced NGAV engine 202 further information regarding the application instance's runtime activity, which enhanced NGAV engine 202 can use to perform a more detailed, behavior-based analysis regarding the application instance's malware status. At the same time, hypervisor-level backup agent 206 can monitor the I/O operations performed by the guest application instance and create, in host-level storage that is inaccessible to VM 106, backups of any data modified by the guest application instance.

Finally, once enhanced NGAV engine 202 has completed its full behavior-based analysis of the guest application instance, enhanced NGAV engine 202 can take an appropriate action in accordance with the result of that analysis. For example, if the full ML-based analysis indicates that the guest application 5nstance is not malicious, enhanced NGAV engine 202 can notify hypervisor-level backup agent 206 to stop backing up the data modified by the guest application instance and to delete all backup data that it has created for the guest application instance to this point. Alternatively, if the full behavior-based analysis indicates that the guest application instance is malicious, enhanced NGAV engine 202 can generate an alert for the administrators of environment 100 and/or optionally take one or more remedial actions (e.g., initiate recovery of the backed-up data).

With the general architecture and workflow described above, a number of advantages are realized. For example, because enhanced NGAV engine 202 does not generate an alert for administrators each time it initially identifies a guest application instance as being malicious, the large volume of false positive alerts created by existing NGAV systems can be avoided.

Further, because hypervisor-level backup agent 206 is integrated into the NGAV system and performs its data backup duties in an intelligent, fine-grained manner (i.e., it only takes backups of data modified by a potentially malicious guest application instance and only takes those backups while enhanced NGAV engine 202 is executing its full behavior-based analysis of the application), the various administrative, storage, and performance overheads associated with implementing a separate, proactive backup solution can be eliminated or reduced. In some embodiments (detailed in section (3) below), enhanced NGAV sensor 204 can provide to enhanced NGAV engine 202 a file map for each file accessed by the guest application instance during its runtime, where this file map identifies logical block address (LBA) to physical block address (PBA) mappings for the data blocks of the file. Hypervisor-level backup agent 206 can use these file maps to monitor for and back up I/O activity directed to the data blocks within the LBA ranges of the file maps and thereby ensure that it only backs up data written to those particular ranges.

Yet further, because hypervisor-level backup agent 206 is part of hypervisor 104 and stores backed-up data in host-level storage that is inaccessible to VM 106, its processing cannot be controlled and its backups cannot be corrupted/deleted by a malicious guest application. Accordingly, this approach is significantly more secure than backup solutions that operate at the guest level.

It should be appreciated that FIG. 2 is illustrative not intended to limit embodiments of the present disclosure. For example, although FIG. 2 depicts a particular arrangement of entities and components within environment 200, other arrangements are possible (e.g., the functionality attributed to a particular component may be split into multiple components, components may be combined, etc.). In addition, environment 200 may include other entities, components, or subcomponents that are not specifically described. One of ordinary skill in the art will recognize other variations, modifications, and alternatives.

### 3. Detailed Solution Workflow

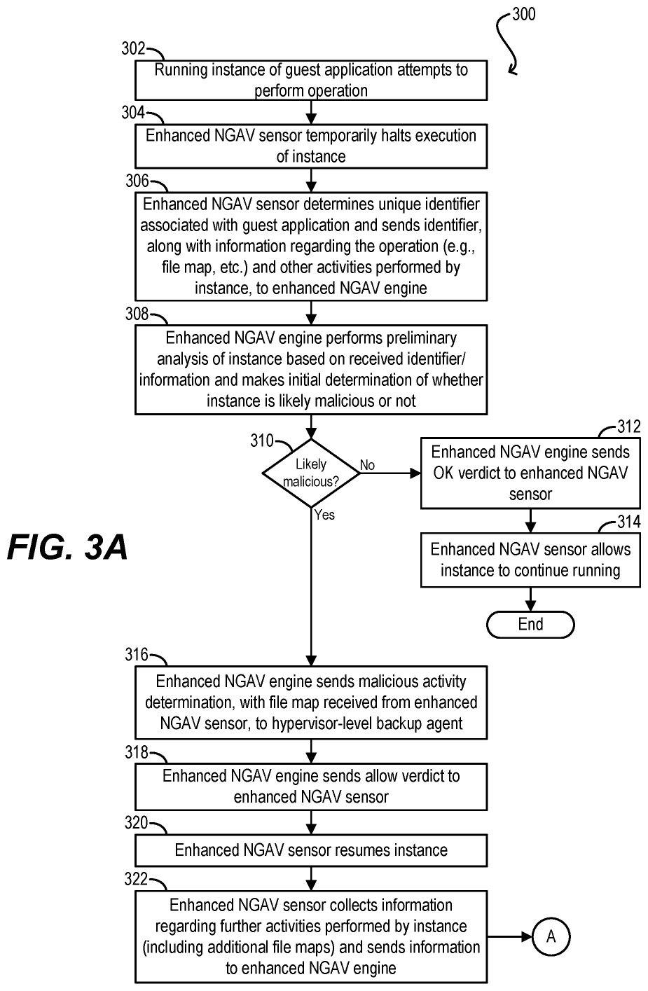

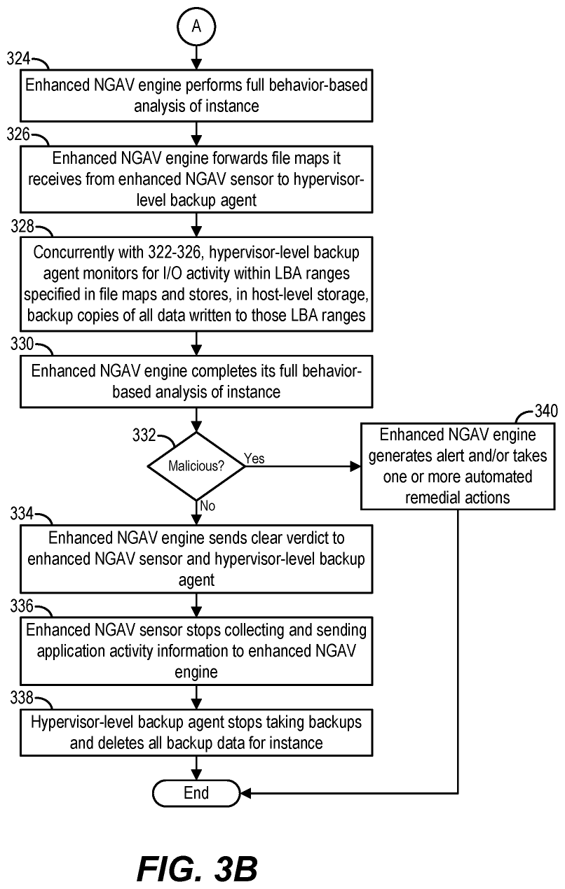

FIGS. 3A and 3B depict a workflow 300 that provides additional details regarding the processing that may be performed by enhanced NGAV engine 202, enhanced NGAV sensor 204, and hypervisor-level backup agent 206 of FIG. 2 with respect to a running instance of a guest application of VM 106 according to certain embodiments.

Starting with step 302 of FIG. 3A, the guest application instance can attempt to perform an operation that may be indicative of malicious behavior (e.g., an attempt to access a file). In some embodiments, this may be the first operation performed by the guest application instance after its startup/initialization.

At step 304, enhanced NGAV sensor 204 can detect the operation and temporarily halt (i.e., pause) execution of the guest application instance. Enhanced NGAV sensor 204 can then determine a unique identifier associated with the guest application (e.g., a cryptographic hash of one or more of the application's files) and send this identifier, along with information regarding the operation and other activity performed by the guest application instance to this point (e.g., file accesses, network activity, registry accesses, etc.), to enhanced NGAV engine 202 (step 306). In certain embodiments, as part of step 306, enhanced NGAV sensor 204 can also send to enhanced NGAV engine 202 a file map for each file accessed by the guest application instance, where the file map includes LBA-to-PBA mappings of the data blocks of the file.

At step 308, enhanced NGAV engine 202 can receive the identifier and information from enhanced NGAV sensor 204 and perform a preliminary analysis using the identifier/information to make an initial determination on whether the guest application instance is likely malicious or not. This preliminary analysis can involve, e.g., matching the activity of the guest application instance to one or more templates of known malware, as well as analyzing the “reputation” of the guest application via reputation information associated with the guest application's identifier that is sourced from one or more third-party databases.

If the initial determination suggests that the guest application instance is not likely malicious (step 310), enhanced NGAV engine 202 can send an indication to that effect (e.g., an “OK” verdict) to enhanced NGAV sensor 204 (step 312). Enhanced NGAV sensor 204 can then allow the guest application instance to continue running (step 314) and the workflow can end.

However, if the initial determination suggests that the guest application instance is likely malicious (step 310), enhanced NGAV engine 202 can send a malware activity indication to hypervisor-level backup agent 206, along with the file map(s) received from enhanced NGAV sensor 204 at step 306 (step 316). Enhanced NGAV engine 202 can also send an “allow” verdict to enhanced NGAV sensor 204 indicating that the guest application instance is likely malware but should be allowed to continue execution (step 318). As mentioned previously, no administrator alert is generated at this time.

In response to the allow verdict, enhanced NGAV sensor 204 can resume the guest application instance (step 320). Further, as the guest application instance is running, enhanced NGAV sensor 204 can collect information regarding further activities performed by the application instance and can send this information to enhanced NGAV engine 202 (step 322). The information collected and sent at step 322 can include file maps of any further files accessed by the guest application instance.

Turning now to FIG. 3B, at step 324, enhanced NGAV engine 202 can use the information received from enhanced NGAV sensor 204 to perform a complete behavior-based analysis of whether the guest application instance is malicious or not. This behavior-based analysis can include, e.g., evaluating and correlating the various activities of the guest application using one or more ML models. Enhanced NGAV engine 202 can also forward the file maps it receives from enhanced NGAV sensor 204 to hypervisor-level backup agent 206 (step 326).

Concurrently with steps 322-326, hypervisor-level backup agent 206 can monitor for I/O activity within the LBA ranges of the file maps received from enhanced NGAV engine 202 and can store, in host-level storage, a backup copy of all data written to those LBA ranges by VM 106 (step 328). In this way, hypervisor-level backup agent 206 can solely backup the data modified by the guest application instance being monitored, without backing up the data of other guest application instances/processes running within VM 106. As used herein, “host-level storage” refers to any storage location that is not visible to, and thus cannot be accessed by, a VM such as VM 106.

At step 330, enhanced NGAV engine 202 can complete its full behavior-based analysis of the guest application instance. If this full analysis indicates that the guest application instance is not malicious (step 332), enhanced NGAV engine 202 can send an indication to that effect (e.g., a clear verdict) to enhanced NGAV sensor 204 and hypervisor-level backup agent 206 (step 334). In response, enhanced NGAV sensor 204 can stop collecting and sending activity information regarding the guest application instance (step 336), and hypervisor-level backup agent 206 can stop taking backups for the file maps associated with the guest application instance and can delete all previously created backup data for the instance (step 338).

Alternatively, if the full analysis indicates that the guest application instance is malicious, enhanced NGAV engine 202 can generate an alert for administrators and/or perform an automated remedial action based on, e.g., an administrator-configured policy (step 340). For example, in one set of embodiments enhanced NGAV engine 202 can automatically terminate execution of the guest application instance and initiating a data recovery process in which engine 202 sends a request to hypervisor-level backup agent 206 to restore the data for the LBA ranges specified in the file maps. Finally, upon completion of either step 338 or 340 the workflow can end.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AIMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

In addition, while certain virtualization methods referenced herein have generally assumed that virtual machines present interfaces consistent with a particular hardware system, persons of ordinary skill in the art will recognize that the methods referenced can be used in conjunction with virtualizations that do not correspond directly to any particular hardware system. Virtualization systems in accordance with the various embodiments, implemented as hosted embodiments, non-hosted embodiments or as embodiments that tend to blur distinctions between the two, are all envisioned. Furthermore, certain virtualization operations can be wholly or partially implemented in hardware.

Many variations, modifications, additions, and improvements are possible, regardless the degree of virtualization. The virtualization software can therefore include components of a host, console, or guest operating system that performs virtualization functions. Plural instances can be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the present disclosure. In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a hypervisor of a host system, an indication of malicious activity with respect to an instance of a guest application running within a virtual machine (VM) of the host system;
receiving, by the hypervisor, information including a range of logical block addresses (LBAs) accessed by the instance;
monitoring, by the hypervisor, for input/output (I/O) activity directed to the range of LBAs; and
upon detecting a write to a data block in the range of LBAs, creating, by the hypervisor, a backup copy of data written via the write to a host-level storage of the host system.

2. The method of claim 1 wherein the indication and the information is received from a next generation anti-virus (NGAV) engine in response to an initial determination made by the NGAV engine that the instance is likely malicious.

3. The method of claim 1 wherein the host-level storage is inaccessible to the instance.

4. The method of claim 1 wherein the range of LBAs corresponds to a file accessed by the instance, and wherein the information is a file map comprising mappings between the range of LBAs and a range of physical block addresses for the file.

5. The method of claim 1 further comprising:
receiving another indication that the instance is not malicious; and
in response to receiving said another indication:
terminating the monitoring; and
deleting the backup copy from the host-level storage.

6. The method of claim 5 wherein said another indication is received from a NGAV engine in response to a behavior-based analysis performed by the NGAV engine indicating that the instance is malicious.

7. The method of claim 6 wherein the NGAV engine performs the behavior-based analysis using activity information regarding the instance that is collected by a NGAV sensor running within the VM.

8. A non-transitory computer readable storage medium having stored thereon program code executable by a hypervisor of a computer system, the program code embodying a method comprising:
receiving an indication of malicious activity with respect to an instance of a guest application running within a virtual machine (VM) of the computer system;
receiving information including a range of logical block addresses (LBAs) accessed by the instance;
monitoring for input/output (I/O) activity directed to the range of LBAs; and
upon detecting a write to a data block in the range of LBAs, creating a backup copy of data written via the write to a host-level storage of the computer system.

9. The non-transitory computer readable storage medium of claim 8 wherein the indication and the information is received from a next generation anti-virus (NGAV) engine in response to an initial determination made by the NGAV engine that the instance is likely malicious.

10. The non-transitory computer readable storage medium of claim 8 wherein the host-level storage is inaccessible to the instance.

11. The non-transitory computer readable storage medium of claim 8 wherein the range of LBAs corresponds to a file accessed by the instance, and wherein the information is a file map comprising mappings between the range of LBAs and a range of physical block addresses for the file.

12. The non-transitory computer readable storage medium of claim 8 wherein the method further comprises:
receiving another indication that the instance is not malicious; and
in response to receiving said another indication:
terminating the monitoring; and
deleting the backup copy from the host-level storage.

13. The non-transitory computer readable storage medium of claim 12 wherein said another indication is received from a NGAV engine in response to a behavior-based analysis performed by the NGAV engine indicating that the instance is malicious.

14. The non-transitory computer readable storage medium of claim 13 wherein the NGAV engine performs the behavior-based analysis using activity information regarding the instance that is collected by a NGAV sensor running within the VM.

15. A computer system comprising:
a processor; and
a non-transitory memory having stored thereon program code that, upon being executed by the processor, causes the processor to:
receive an indication of malicious activity with respect to an instance of a guest application running within a virtual machine (VM) of the computer system;
receive information including a range of logical block addresses (LBAs) accessed by the instance;
monitor for input/output (I/O) activity directed to the range of LBAs; and
upon detecting a write to a data block in the range of LBAs, create a backup copy of data written via the write to a host-level storage of the computer system.

16. The computer system of claim 15 wherein the indication and the information is received from a next generation anti-virus (NGAV) engine in response to an initial determination made by the NGAV engine that the instance is likely malicious.

17. The computer system of claim 15 wherein the host-level storage is inaccessible to the instance.

18. The computer system of claim 15 wherein the range of LBAs corresponds to a file accessed by the instance, and wherein the information is a file map comprising mappings between the range of LBAs and a range of physical block addresses for the file.

19. The computer system of claim 15 wherein the program code further causes the processor to:
receive another indication that the instance is not malicious; and
in response to receiving said another indication:
terminate the monitoring; and
delete the backup copy from the host-level storage.

20. The computer system of claim 19 wherein said another indication is received from a NGAV engine in response to a behavior-based analysis performed by the NGAV engine indicating that the instance is malicious.

21. The computer system of claim 20 wherein the NGAV engine performs the behavior-based analysis using activity information regarding the instance that is collected by a NGAV sensor running within the VM.
